(19) United States
(12) Patent Application Publication
(10) Pub. No.: US 2016/0211881 A1
(43) Pub. Date: Jul. 21, 2016

(54) WIRELESS COMMUNICATION DEVICE CAPABLE OF ADJUSTING AT LEAST ONE ANTENNA TO IMPROVE EFFICIENCY OF OTHER COEXISTING ANTENNA(S) AND RELATED WIRELESS COMMUNICATION METHOD

(71) Applicant: MEDIATEK INC., Taiwan (CN)

(72) Inventors: Ting-Wei Kang, Kaohsiung City (TW); Shih-Huang Yeh, Hsinchu City (TW)

(21) Appl. No.: 14/914,629

(22) PCT Filed: Jul. 24, 2015
(86) PCT No.: PCT/CN2015/085044

§ 371 Date: Feb. 25, 2016

Related U.S. Application Data
(60) Provisional application No. 62/028,947, filed on Jul. 25, 2014.

(51) Int. Cl. H04B 1/44; H04B 7/04

(52) U.S. Cl. CPC H04B 1/44; H04B 7/04

(57) ABSTRACT

A wireless communication device is used for performing wireless communication via at least one of a plurality of antennas. The antennas include a first antenna and a second antenna. The first antenna includes at least one first controllable component. The wireless communication device has at least one communication system and a control circuit. The at least one communication system is used to perform the wireless communication via at least one of the plurality of antennas. The control circuit is used to set the at least one first controllable component according to a first setting when the first antenna and the second antenna are active, and set the at least one first controllable component according to a second setting when the first antenna is inactive and the second antenna is active, where the second setting is different from the first setting.

### CROSS REFERENCE TO RELATED APPLICATIONS

This application claims the benefit of U.S. provisional application No. 62/028,947, filed on Jul. 25, 2014 and incorporated herein by reference.

### TECHNICAL FIELD

The disclosed embodiments of the present invention relate to wireless communication, and more particularly, to a wireless communication device capable of adjusting at least one antenna to improve efficiency of other coexisting antenna(s) and a related wireless communication method.

### BACKGROUND

An antenna is an electrical component that is needed to transmit and receive electromagnetic energy from the space surrounding it in order to establish a wireless connection between two or more electronic devices, such as mobile phone(s), tablet(s), wearable device(s), base station(s) and/or wireless local area network (WLAN) device(s). It is possible that a single device may be configured to support a variety of communication standards. Hence, multiple antennas and multiple communication systems may coexist in the same electronic device. However, multi-antenna coexistence may degrade efficiency of each antenna, especially for the low-frequency band. Hence, there is a need for an innovative design which can avoid/mitigate unnecessary antenna performance degradation.

### SUMMARY

In accordance with exemplary embodiments of the present invention, a wireless communication device capable of adjusting at least one antenna to improve efficiency of other coexisting antenna(s) and a related wireless communication method are proposed.

According to a first aspect of the present invention, an exemplary wireless communication device is disclosed. The exemplary wireless communication device is used for performing wireless communication via at least one of a plurality of antennas. The antennas include a first antenna and a second antenna. The first antenna includes at least one first controllable component. The exemplary wireless communication device includes at least one communication system and a control circuit. The at least one communication system is used to perform the wireless communication via at least one of the plurality of antennas. The control circuit is arranged to set the at least one first controllable component according to a first setting when the first antenna and the second antenna are active, and set the at least one first controllable component according to a second setting when the first antenna is inactive and the second antenna is active, wherein the second setting is different from the first setting.

According to a second aspect of the present invention, an exemplary wireless communication method is disclosed. The exemplary wireless communication method is used for performing wireless communication via at least one of a plurality of antennas. The antennas include a first antenna and a second antenna. The first antenna includes at least one first controllable component. The exemplary wireless communication method includes: configuring at least one communication system to perform the wireless communication via at least one of the plurality of antennas; when the first antenna and the second antenna are active, setting the at least one first controllable component according to a first setting; and when the first antenna is inactive and the second antenna is active, setting the at least one first controllable component according to a second setting different from the first setting.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram illustrating a wireless communication device according to an embodiment of the present invention.

FIG. 2 is a diagram illustrating an exemplary design of the antennas shown in FIG. 1.

FIG. 3 is a diagram illustrating the performance of the antennas when the proposed solution is not enabled.

FIG. 4 is a diagram illustrating the performance of the antennas when the proposed solution is enabled.

FIG. 5 is a diagram illustrating the efficiency of the antenna when the proposed solution is not enabled and the efficiency of the antenna when the proposed solution is enabled.

FIG. 6 is a flowchart illustrating a wireless communication method according to an embodiment of the present invention.

FIG. 7 is a diagram illustrating another wireless communication device according to an embodiment of the present invention.

FIG. 8 is a flowchart illustrating another wireless communication method according to an embodiment of the present invention.

FIG. 9 is a diagram illustrating one alternative wireless communication device according to an embodiment of the present invention.

FIG. 10 is a diagram illustrating another alternative wireless communication device according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

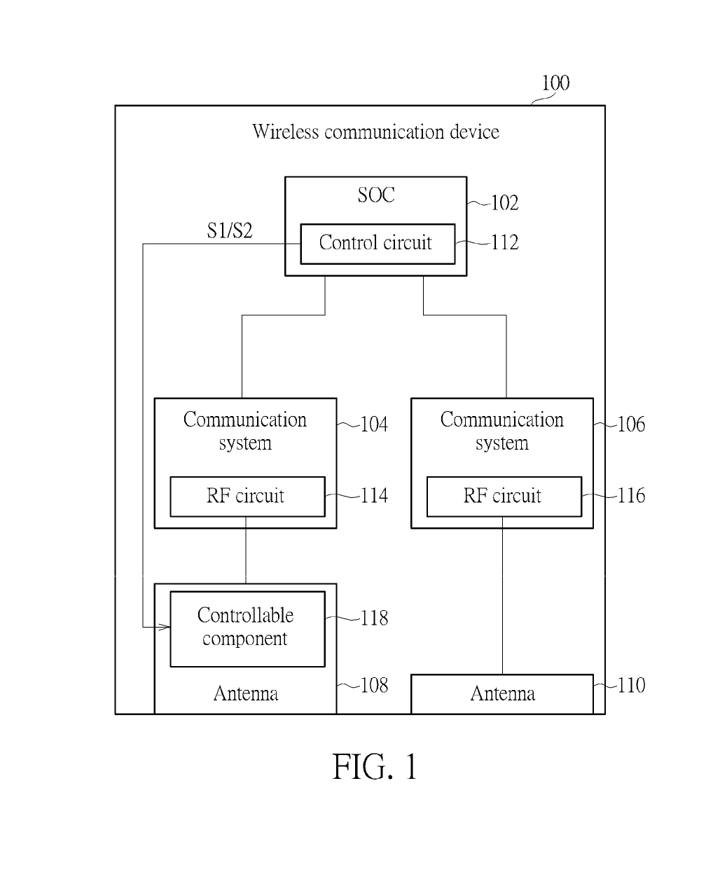

FIG. 1 is a diagram illustrating a wireless communication device according to an embodiment of the present invention. The wireless communication device 100 may be implemented in a mobile phone, a tablet, a wearable device or any other device capable of performing wireless communication. For example, the wireless communication device 100 may be a DSDA (Dual-SIM Dual-Active) device or an SV-LTE (Simultaneous Voice and LTE) device. Hence, multiple antennas and multiple communication systems may be implemented in the same wireless communication device 100. In this embodiment, the wireless communication device 100 may include a system-on-chip (SOC) 102, a plurality of communication systems 104 and 106, and a plurality of antennas 108 and 110. The SOC 102 may include an application processor (AP), a baseband (BB) processor and other circuit components. In this embodiment, a control circuit 112 may be implemented in the SOC 102. It should be noted that using the SOC 102 in the wireless communication device 100 is for illustrative purposes only, and is not meant to be a limitation of the present invention. Alternatively, the SOC 102 may be replaced by a processing unit, such that the control circuit 112 may be part of the processing unit. The communication system 104 may be a transceiver arranged to up-convert a baseband signal generated from the baseband processor in the SOC 102 into a radio-frequency (RF) signal for transmission over the air through the antenna 108 in a transmit (TX) mode, and further arranged to down-convert an RF signal received from the antenna 108 into a baseband signal for further processing in a receive (RX) mode. Similarly, the communication system 106 may be a transceiver arranged to up-convert a baseband signal generated from the baseband processor in the SOC 102 into an RF signal for transmission over the air through the antenna 110 in a TX mode, and further arranged to down-convert an RF signal received from the antenna 110 into a baseband signal for further processing in an RX mode.

In this embodiment, the communication systems 104 and 106 may have RF circuits 114 and 116 for outputting RF signals in the TX mode and receiving RF signals in the RX mode. Hence, the RF circuit 114 may be coupled to the antenna 108 for RF signal transmission and reception, and the RF circuit 116 may be coupled to the antenna 110 for RF signal transmission and reception. In this embodiment, the antenna 108 may have at least one controllable component 118 controlled by the control circuit 112. When the antennas 108 and 110 may be active (e.g. communication systems 104 and 106 may be active), the control circuit 112 may set the at least one controllable component 118 according to a first setting S1. When the antenna 108 may be inactive (e.g., communication system 104 may be inactive) and the antenna 110 may be active (e.g., communication system 106 may be active), the control circuit 112 may set the at least one controllable component 118 according to a second setting S2 different from the first setting S1.

For example, the at least one controllable component 118 may include at least one of a diode, a switch, a tunable capacitor and an impedance matching module (which may be, for example, composed of a switch and a tunable capacitor). In a first case where the at least one controllable component 118 may include a diode, the diode may be controlled by the first setting S1 to be conductive, and may be controlled by the second setting S2 to be non-conductive. In a second case where the at least one controllable component 118 may include a switch, the switch may be controlled by the first setting S1 to be switched on (or switched to one input/output node), and may be controlled by the second setting S2 to be switched off (or switched to another input/output node). In a third case where the at least one controllable component 118 may include a tunable capacitor, the tunable capacitor may be controlled by the first setting S1 to have a first capacitance value, and may be controlled by the second setting S2 to have a second capacitance value different from the first capacitance value. In a fourth case where the at least one controllable component 118 may include an impedance matching module, the impedance matching module may be controlled by the first setting S1 to have a first impedance value, and may be controlled by the second setting S2 to have a second impedance value different from the first impedance value. However, these are for illustrative purposes only, and are not meant to be limitations of the present invention.

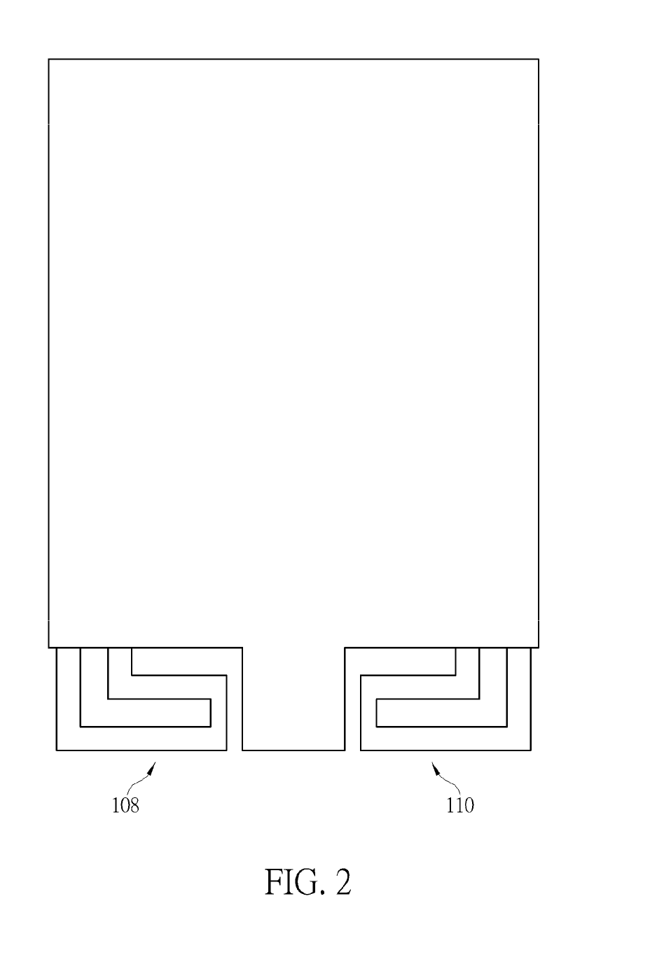

As mentioned above, multi-antenna coexistence may degrade efficiency of each antenna. FIG. 2 is a diagram illustrating an exemplary design of the antennas 108 and 110 shown in FIG. 1. It should be noted that the antenna structure shown in FIG. 2 is for illustrative purposes only, and is not meant to be a limitation of the present invention. In practice, the present invention has no limitations on the actual antenna structure of the antennas 108 and 110. The existence of the antenna 108 may degrade the efficiency of the antenna 110, and the existence of the antenna 110 may degrade the efficiency of the antenna 108. In this embodiment, the first setting S1 and the second setting S2 may be configured for impedance matching adjustment. Hence, the at least one controllable component 118 may be used to adjust the impedance matching of the antenna 108, such that the antenna 108 may have different impedance matching conditions under the first setting S1 and the second setting S2. With the proper control of the impedance matching of the antenna 108, the efficiency degradation of the antenna 110 caused by the coexisting antenna 108 can be avoided/mitigated.

In this embodiment, the second setting S2 may be set by the control circuit 112 to intentionally degrade the impedance matching of the antenna 108, thereby enforcing the antenna 108 to have poorer antenna efficiency. In this way, the isolation between the antennas 108 and 110 may be improved, thus making the antenna 110 have better antenna efficiency. By way of example, but not limitation, the antenna efficiency may be radiation efficiency which is defined as the ratio of the total power radiated by an antenna to the net power received by the antenna from the connected transmitter.

To put it another way, efficiency of the antenna 108 with the at least one controllable component 118 set according to the second setting S2 may be lower than efficiency of the antenna 108 with the at least one controllable component 118 set according to the first setting S1; isolation between the antennas 108 and 110 under a condition that the at least one controllable component 118 is set according to the second setting S2 may be higher than isolation between the antennas 108 and 110 under a condition that the at least one controllable component 118 is set according to the first setting S1; and efficiency of the antenna 110 under a condition that the at least one controllable component 118 is set according to the second setting S2 may be higher than efficiency of the antenna 110 under a condition that the at least one controllable component 118 is set according to the first setting S1.

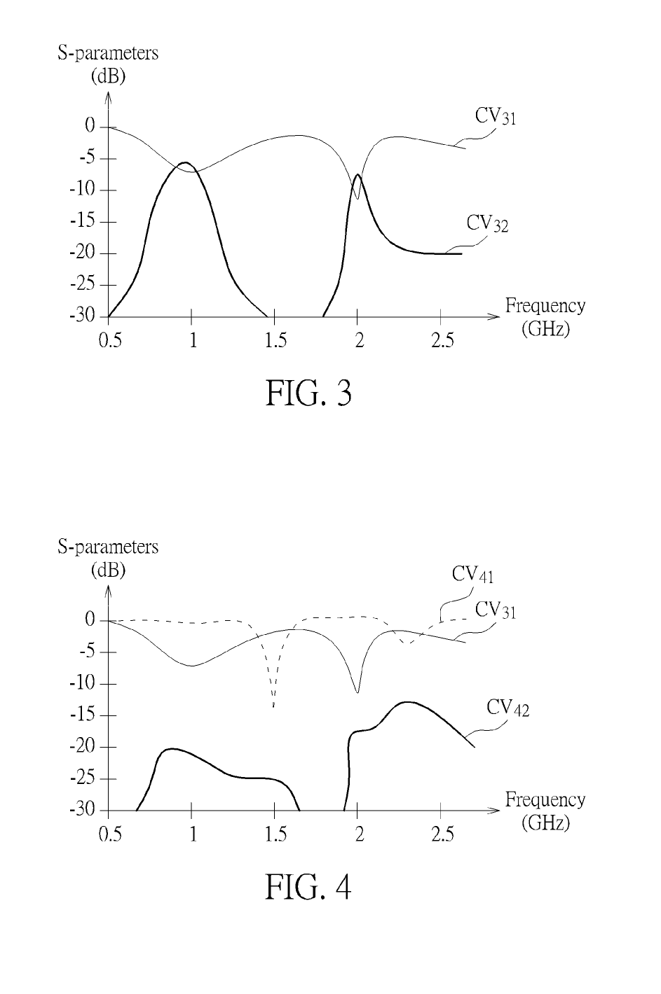

Please refer to FIG. 3 in conjunction with FIG. 4. FIG. 3 is a diagram illustrating the performance of the antennas 108 and 110 when the proposed solution is not enabled. FIG. 4 is a diagram illustrating the performance of the antennas 108 and 110 when the proposed solution is enabled. For clarity and simplicity, it is assumed that the antennas 108 and 110 may have the same structure and characteristics. In FIG. 3, the characteristic curve CV₃₁ shows the S-parameter S₁₁ of each of the antennas 108 and 110, where the S-parameter S₁₁ may be indicative of the return loss; and the characteristic curve CV₃₂ shows the S-parameter S₂₁ of each of the antennas 108 and 110, where the S-parameter S₂₁ may be indicative of the isolation loss. In FIG. 4, the characteristic curve CV₃₁ shows the S-parameter S₁₁ of the antenna 110, the characteristic curve CV₄₁ shows the S-parameter S₁₁ of the antenna 108, and the characteristic curve CV₄₂ shows the S-parameter S₂₁ of each of the antennas 108 and 110. As can be seen from the characteristic curve CV₃₂ in FIG. 3 and the characteristic curve CV₄₂ in FIG. 4, the proposed solution can effectively improve the isolation between the antennas 108 and 110, especially in the low-frequency communication band. In this way, when the antenna 108 may be inactive (e.g., communication system 104 may be inactive) and the antenna 110 may be active (e.g., communication system 106 may be active), the efficiency of the antenna 110 may be improved, especially in the low-frequency communication band.

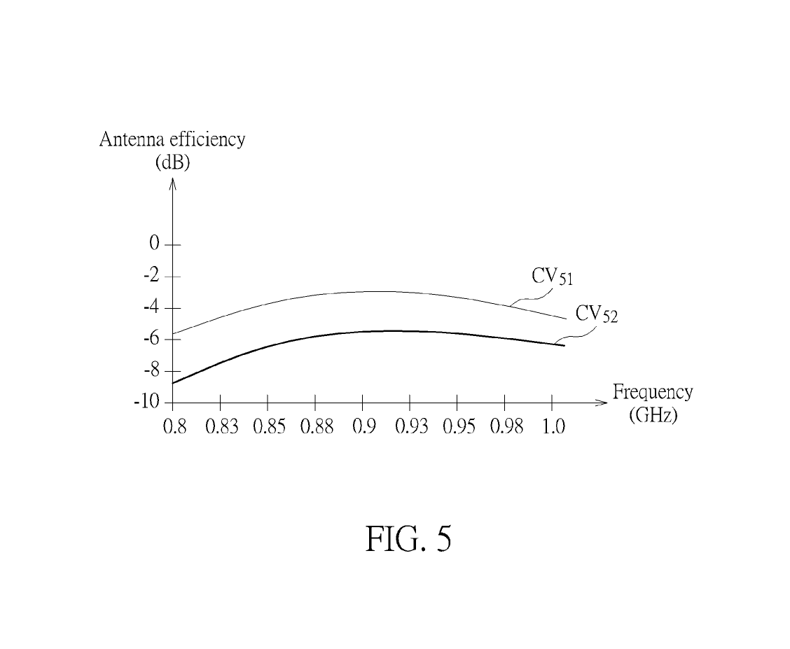

FIG. 5 is a diagram illustrating the efficiency of the antenna 110 when the proposed solution is not enabled and the efficiency of the antenna 110 when the proposed solution is enabled, where the characteristic curve CV₅₁ shows the efficiency of the antenna 110 when the proposed solution is enabled, and the characteristic curve CV₅₂ shows the efficiency of the antenna 110 when the proposed solution is not enabled. As can be seen from FIG. 5, the efficiency of the antenna 110 in the low-frequency communication band may be improved by the proposed solution.

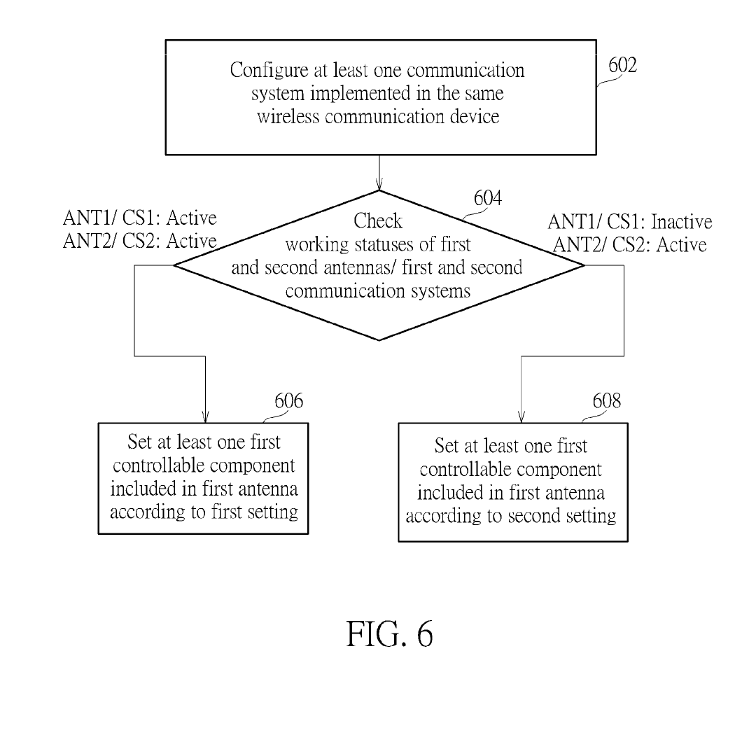

FIG. 6 is a flowchart illustrating a wireless communication method according to an embodiment of the present invention. The wireless communication method may be employed by the wireless communication device 100 for antenna efficiency improvement of one antenna operating under a multi-antenna coexistence environment. Provided that the result is substantially the same, the steps are not required to be executed in the exact order shown in FIG. 6. Besides, one or more steps may be omitted from or added to the flow shown in FIG. 6. The wireless communication method may be briefly summarized as below.
Step 602: Configure at least one communication system implemented in the same wireless communication device. For example, the at least one communication system may include a first communication system CS1 and a second communication system CS2. The first communication system CS1 may perform communication in at least a first communication band via a first antenna ANT 1, where the first antenna ANT1 may have at least one first controllable component. The second communication system CS2 may perform communication in at least a second communication band via a second antenna ANT2. For example, the first communication band may be overlapped with the second communication band.
Step 604: Check the working statuses of the first antenna ANT1 and the second antenna ANT2 (e.g., working statuses of the first communication system CS1 and the second communication system CS2). When the first antenna ANT1 and the second antenna ANT2 are active (e.g., first communication system CS1 and second communication system CS2 are active), go to step 606. When the first antenna ANT1 is inactive (e.g., first communication system CS1 is inactive) and the second antenna ANT2 is active (e.g., second communication system CS2 is active), go to step 608.
Step 606: Set the at least one first controllable component according to a first setting.
Step 608: Set the at least one first controllable component according to a second setting different from the first setting.

In a case where the wireless communication device may be a mobile phone, the communication systems implemented in the same wireless communication device may be configured on the basis of the current operation mode of the mobile phone (Step 602). For example, the first antenna ANT1 may be designed to operate in a frequency band ranging from 704 Mhz to 2690 Mhz, and the second antenna ANT2 may be designed to operate in a frequency band ranging from 824 Mhz to 1990 Mhz. Hence, the first antenna ANT1 may be suitable for an LTE data communication, and the second antenna ANT2 may be suitable for a GSM/CDMA2000 (also known as C2K) voice communication. In addition, the first antenna ANT1 may be inactive when the first communication system CS1 is inactive, and the second antenna ANT2 may be inactive when the second communication system CS2 is inactive. When the wireless communication device is configured to operate in an SV-LTE mode, the first communication system CS1 may be active to deal with the LTE data communication via the first antenna ANT1, and the second communication system CS2 may be active to deal with the GSM/CDMA2000 voice communication via the second antenna ANT2. Hence, the at least one first controllable component included in the first antenna ANT1 may be set by the first setting to make the first antenna ANT1 have a good impedance matching condition for achieving better antenna efficiency (step 606). When the wireless communication device is configured to operate in a voice communication mode, the first communication system CS1 may be inactive, and the second communication system CS2 may be active to deal with the GSM/CDMA2000 voice communication via the second antenna ANT2. Since the first communication system CS1 may be inactive under the current operation mode of the mobile phone, the first antenna ANT1 may be idle/inactive at this moment. To avoid/mitigate the performance degradation of the second antenna ANT2 that is caused by the coexisting first antenna ANT1, the at least one first controllable component included in the first antenna ANT1 may be set by the second setting to intentionally make the first antenna ANT1 have a degraded impedance matching condition for achieving poorer antenna efficiency (step 608).

For example, each of the first communication band and the second communication band may be below 1 GHz. Hence, with a proper configuration of the at least one first controllable component included in the first antenna, the proposed solution may avoid/mitigate the performance degradation of the second antenna in the low-frequency communication band when the first communication system/first antenna may be inactive and the second communication system/second antenna may be active.

For another example, each of the first communication band and the second communication band may be above 1 GHz. Hence, with a proper configuration of the at least one first controllable component included in the first antenna, the proposed solution may avoid/mitigate the performance degradation of the second antenna in the high-frequency communication band when the first communication system/first antenna may be inactive and the second communication system/second antenna may be active.

As a person skilled in the art can readily understand details of each step shown in FIG. 6 after reading above paragraphs, further description is omitted here for brevity.

With regard to the embodiment shown in FIG. 1, the proposed antenna efficiency improvement technique may be employed to improve the efficiency of one antenna under one operation mode of the wireless communication device. However, this is for illustrative purposes only, and is not meant to be a limitation of the present invention. In an alternative design, the aforementioned antenna efficiency improvement technique may be employed to improve the efficiency of more than one antenna under different operation modes of the wireless communication device.

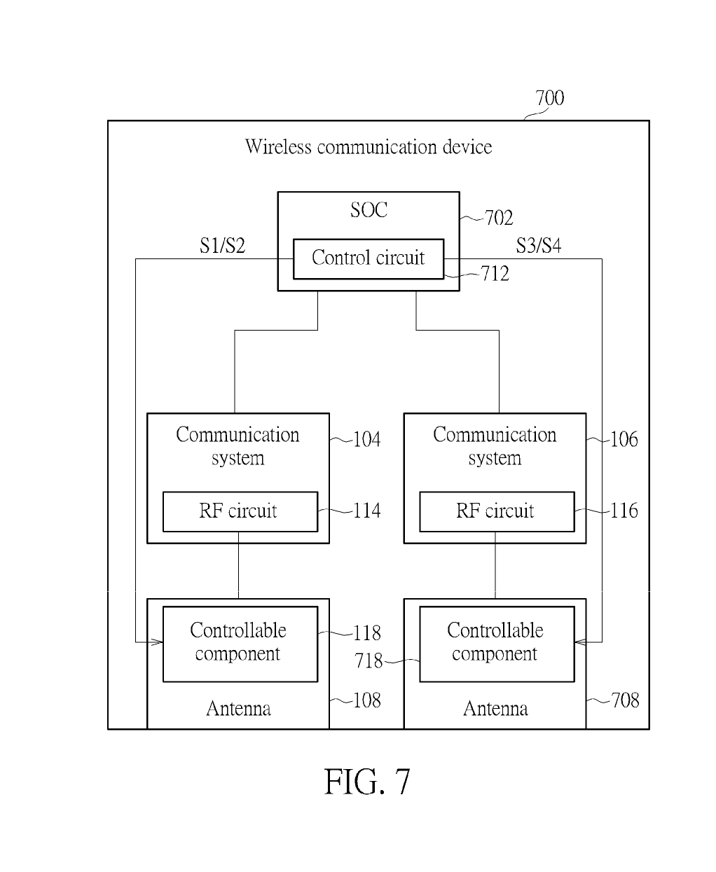

FIG. 7 is a diagram illustrating another wireless communication device according to an embodiment of the present invention. The wireless communication device 700 may be implemented in a mobile phone, a tablet, a wearable device or any other device capable of performing wireless communication. For example, the wireless communication device 700 may be a DSDA device or an SV-LTE device. Hence, multiple antennas and multiple communication systems may be implemented in the same wireless communication device 700. The wireless communication device 700 may be obtained by applying some modifications to the wireless communication device 100 shown in FIG. 1. For example, the antenna 110 may be replaced by the antenna 708 having at least one controllable component 718, and the SOC 102 may be replaced by the SOC 702 having a control circuit 712 arranged to generate one setting to the antenna 108 (particularly, the at least one controllable component 118 in the antenna 108) and further generate another setting to the antenna 708 (particularly, the at least one controllable component 718 in the antenna 708). It should be noted that using the SOC 702 in the wireless communication device 700 is for illustrative purposes only, and is not meant to be a limitation of the present invention. Alternatively, the SOC 702 may be replaced by a processing unit, such that the control circuit 712 may be part of the processing unit.

When the antennas 108 and 708 may be active (e.g., communication systems 104 and 106 may be active), the control circuit 712 may set the at least one controllable component 118 included in the antenna 108 according to the first setting 51, and may set the at least one controllable component 718 included in the antenna 708 according to a third setting S3. When the antenna 108 may be inactive (e.g., communication system 104 may be inactive) and the antenna 708 may be active (e.g., communication system 106 may be active), the control circuit 712 may set the at least one controllable component 118 included in the antenna 108 according to the second setting S2 (S2≠S1), and may set the at least one controllable component 718 included in the antenna 708 according to the third setting S3. When the antenna 108 may be active (e.g., communication system 104 may be active) and the antenna 708 may be inactive (e.g., communication system 106 may be inactive), the control circuit 712 may set the at least one controllable component 118 included in the antenna 108 according to the first setting S1, and may set the at least one controllable component 718 included in the antenna 708 according to a fourth setting S4 different from the third setting S3.

Like the at least one controllable component 118 mentioned above, the at least one controllable component 718 may include, for example, at least one of a diode, a switch, a tunable capacitor and an impedance matching module (which may be, for example, composed of a switch and a tunable capacitor). In a first case where the at least one controllable component 718 may include a diode, the diode may be controlled by the third setting S3 to be conductive, and may be controlled by the fourth setting S4 to be non-conductive. In a second case where the at least one controllable component 718 may include a switch, the switch may be controlled by the third setting S3 to be switched on (or switched to a first input/output node), and may be controlled by the fourth setting S4 to be switched off (or switched to a second input/output node). In a third case where the at least one controllable component 718 may include a tunable capacitor, the tunable capacitor may be controlled by the third setting S3 to have a first capacitance value, and may be controlled by the fourth setting S4 to have a second capacitance value different from the first capacitance value. In a fourth case where the at least one controllable component 718 may include an impedance matching module, the impedance matching module may be controlled by the third setting S3 to have a first impedance value, and may be controlled by the fourth setting S4 to have a second impedance value different from the first impedance value. However, these are for illustrative purposes only, and are not meant to be limitations of the present invention.

As mentioned above, multi-antenna coexistence may degrade efficiency of each antenna. In this embodiment, the first setting S1, the second setting S2, the third setting S3 and the fourth setting S4 may be used for impedance matching adjustment. Hence, the at least one controllable component 118 may be used to adjust the impedance matching of the antenna 108, such that the antenna 108 may have different impedance matching conditions under the first setting S1 and the second setting S2; and the at least one controllable component 718 may be used to adjust the impedance matching of the antenna 708, such that the antenna 708 may have different impedance matching conditions under the third setting S3 and the fourth setting S4.

With the proper control of the impedance matching of the antenna 108, the efficiency degradation of the antenna 708 that is caused by the coexisting antenna 108 can be avoided/mitigated under the condition that the antenna 108 is inactive (e.g., communication system 104 is inactive) and the antenna 708 is active (e.g., communication system 106 is active). In this embodiment, the second setting S2 may be set by the control circuit 712 to intentionally degrade the impedance matching of the antenna 108, thereby enforcing the antenna 108 to have poorer antenna efficiency (e.g., poorer radiation efficiency). In this way, the isolation between the antennas 108 and 708 may be improved, thus making the antenna 708 have better antenna efficiency.

To put it another way, efficiency of the antenna 108 with the at least one controllable component 118 set according to the second setting S2 may be lower than efficiency of the antenna 108 with the at least one controllable component 118 set according to the first setting S1; isolation between the antennas 108 and 708 under a condition that the at least one controllable component 118 is set according to the second setting S2 may be higher than isolation between the antennas 108 and 708 under a condition that the at least one controllable component 118 is set according to the first setting S1; and efficiency of the antenna 708 under a condition that the at least one controllable component 118 is set according to the second setting S2 may be higher than efficiency of the antenna 708 under a condition that the at least one controllable component 118 is set according to the first setting S1.

Similarly, with the proper control of the impedance matching of the antenna 708, the efficiency degradation of the antenna 108 that is caused by the coexisting antenna 708 can be avoided/mitigated under the condition that the communication system 104 is active and the communication system 106 is inactive. In this embodiment, the fourth setting S4 may be set by the control circuit 712 to intentionally degrade the impedance matching of the antenna 708, thereby enforcing the antenna 708 to have poorer antenna efficiency (e.g., poorer radiation efficiency). In this way, the isolation between the antennas 108 and 708 may be improved, thus making the antenna 108 have better antenna efficiency.

To put it another way, efficiency of the antenna 708 with the at least one controllable component 718 set according to the fourth setting S4 may be lower than efficiency of the antenna 708 with the at least one controllable component 718 set according to the third setting S3; isolation between the antennas 108 and 708 under a condition that the at least one controllable component 718 is set according to the fourth setting S4 may be higher than isolation between the antennas 108 and 708 under a condition that the at least one controllable component 718 is set according to the third setting S3; and efficiency of the antenna 108 under a condition that the at least one controllable component 718 is set according to the fourth setting S4 may be higher than efficiency of the antenna 108 under a condition that the at least one controllable component 718 is set according to the third setting S3.

The performance comparison between the wireless communication device 700 with the proposed solution enabled and the wireless communication device 700 with the proposed solution disabled is illustrated in the following table, where the communication system 106 (denoted by CS2) uses the antenna 708 (denoted by ANT2) for RF signal transmission, and the communication system 104 (denoted by CS1) uses the antenna 108 (denoted by ANT1) for RF signal transmission.

| | Peak Efficiency (dB) | | | | | |
|---|---|---|---|---|---|---|
| | w/o Solution | | w/Solution | | Improvement | |
| Scenario | ANT 1 | ANT 2 | ANT 1 | ANT 2 | ANT 1 | ANT2 |
| CS 1 (Active) | −6.1 | −6.1 | −6.1 | −6.1 | — | — |
| CS 2 (Active) | | | | | | |
| CS 1 (Active) | −6.1 | | −4.5 | | 1.6 | |
| CS 2 (Inactive) | | | | | | |
| CS 1 (Inactive) | | −6.1 | | −4.5 | | 1.6 |
| CS 2 (Active) | | | | | | |

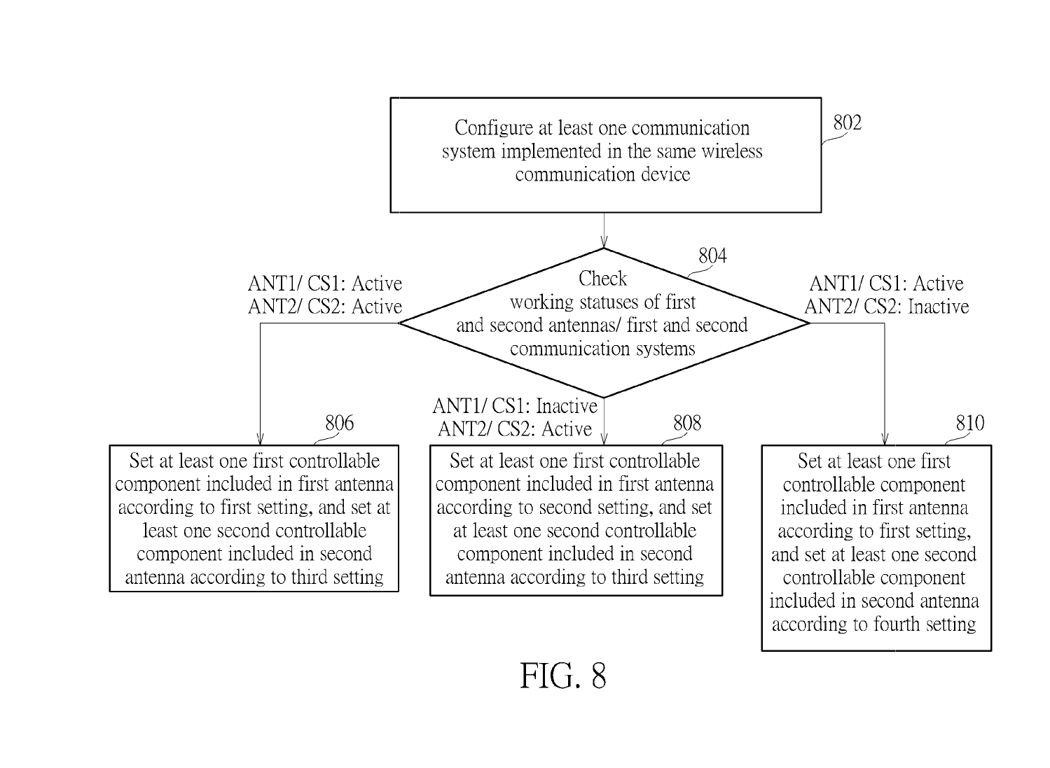

FIG. 8 is a flowchart illustrating another wireless communication method according to an embodiment of the present invention. The wireless communication method may be employed by the wireless communication device 700 for antenna efficiency improvement of antennas operating under a multi-antenna coexistence environment. Provided that the result is substantially the same, the steps are not required to be executed in the exact order shown in FIG. 8. Besides, one or more steps can be omitted from or added to the flow shown in FIG. 8. The wireless communication method may be briefly summarized as below.
Step 802: Configure at least one communication system implemented in the same wireless communication device. For example, the at least one communication system may include a first communication system CS1 and a second communication system CS2. The first communication system CS1 may perform communication in at least a first communication band via a first antenna ANT 1, where the first antenna ANT1 may have at least one first controllable component. The second communication system CS2 may perform communication in at least a second communication band via a second antenna ANT2, where the second antenna ANT2 may have at least one second controllable component. For example, the first communication band may be overlapped with the second communication band.
Step 804: Check the working statuses of the first antenna ANT1 and the second antenna ANT2 (e.g., working statuses of the first communication system CS1 and the second communication system CS2). When the first antenna ANT1 and the second antenna ANT2 are active (e.g., the first communication system CS1 and the second communication system CS2 are active), go to step 806. When the first antenna ANT1 is inactive (e.g., first communication system CS1 is inactive) and the second antenna ANT2 is active (e.g., second communication system CS2 is active), go to step 808. When the first antenna ANT1 is active (e.g., first communication system CS1 is active) and the second antenna ANT2 is inactive (e.g., second communication system CS2 is inactive), go to step 810.
Step 806: Set the at least one first controllable component included in the first antenna ANT1 according to a first setting, and set the at least one second controllable component included in the second antenna ANT2 according to a third setting.
Step 808: Set the at least one first controllable component included in the first antenna ANT1 according to a second setting different from the first setting, and set the at least one second controllable component included in the second antenna ANT2 according to the third setting.
Step 810: Set the at least one first controllable component included in the first antenna ANT1 according to the first setting, and set the at least one second controllable component included in the second antenna ANT2 according to a fourth setting different from the third setting.

In a case where the wireless communication device is a mobile phone, the communication systems implemented in the same wireless communication device may be configured according the current operation mode of the mobile phone (Step 802). For example, the first antenna ANT1 may be designed to operate in a frequency band ranging from 704 Mhz to 2690 Mhz, and the second antenna ANT2 may be designed to operate in a frequency band ranging from 824 Mhz to 1990 Mhz. Hence, the first antenna ANT1 may be suitable for an LTE data communication, and the second antenna ANT2 may be suitable for a GSM/CDMA2000 voice communication. In addition, the first antenna ANT1 may be inactive when the first communication system CS1 is inactive, and the second antenna ANT2 may be inactive when the second communication system CS2 is inactive.

When the wireless communication device is configured to operate in an SV-LTE mode, the first communication system CS1 may be active to deal with the LTE data communication via the first antenna ANT1, and the second communication system CS2 may be active to deal with the GSM/CDMA2000 voice communication via the second antenna ANT2. Hence, the at least one first controllable component included in the first antenna ANT1 may be set by the first setting to make the first antenna ANT1 have a good impedance matching condition for achieving better antenna efficiency, and the at least one second controllable component included in the second antenna ANT2 may be set by the third setting to make the second antenna ANT2 have a good impedance matching condition for achieving better antenna efficiency (step 806).

When the wireless communication device is configured to operate in a voice communication mode, the first communication system CS1 may be inactive, and the second communication system CS2 may be active to deal with the GSM/CDMA2000 voice communication via the second antenna ANT2. Since the first communication system CS1 is inactive, the first antenna ANT1 may be idle/inactive at this moment. To avoid/mitigate the performance degradation of the second antenna ANT2 that is caused by the coexisting first antenna ANT1, the at least one first controllable component included in the first antenna ANT1 may be set by the second setting to intentionally make the first antenna ANT1 have a degraded impedance matching condition for achieving poorer antenna efficiency (step 808).

For example, each of the first communication band and the second communication band may be below 1 GHz. Hence, with a proper configuration of the at least one first controllable component included in the first antenna, the proposed solution may avoid/mitigate the performance degradation of the second antenna in the low-frequency communication band when the first communication system/first antenna may be inactive and the second communication system/second antenna may be active.

For another example, each of the first communication band and the second communication band may be above 1 GHz. Hence, with a proper configuration of the at least one first controllable component included in the first antenna, the proposed solution may avoid/mitigate the performance degradation of the second antenna in the high-frequency communication band when the first communication system/first antenna may be inactive and the second communication system/second antenna may be active.

When the wireless communication device is configured to operate in an LTE data communication mode, the second communication system CS2 may be inactive, and the first communication system CS1 may be active to deal with the LTE data communication via the first antenna ANT1. Since the second communication system CS2 is inactive, the second antenna ANT2 may be idle/inactive at this moment. To avoid/mitigate the performance degradation of the first antenna ANT1 that is caused by the coexisting second antenna ANT2, the at least one second controllable component included in the second antenna ANT2 may be set by the fourth setting to intentionally make the second antenna have a degraded impedance matching condition for achieving poorer antenna efficiency (step 810).

For example, each of the first communication band and the second communication band may be below 1 GHz. Hence, with a proper configuration of the at least one second controllable component included in the second antenna, the proposed solution may avoid/mitigate the performance degradation of the first antenna in the low-frequency communication band when the first communication system/first antenna may be active and the second communication system/second antenna may be inactive.

For another example, each of the first communication band and the second communication band may be above 1 GHz. Hence, with a proper configuration of the at least one second controllable component included in the second antenna, the proposed solution may avoid/mitigate the performance degradation of the first antenna in the high-frequency communication band when the first communication system/first antenna may be active and the second communication system/second antenna may be inactive.

As a person skilled in the art can readily understand details of each step shown in FIG. 8 after reading above paragraphs, further description is omitted here for brevity.

The proposed solution can improve the wireless communication performance without adding more production cost and/or printed circuit board (PCB) layout area. The example in FIG. 7 shows that the proposed solution can have a 1.6 dB radiation efficiency improvement. When the number of coexisting antennas is 3 or more, a larger radiation efficiency improvement can be achieved by using the proposed solution. In addition, the proposed solution may not alter the antenna structure, and can be applied to any wireless communication device using multiple antennas (e.g., an LTE device or an LTE-A device).

It should be noted that the embodiments shown in FIG. 1 and FIG. 7 are for illustrative purposes only. In practice, the proposed antenna efficiency improvement technique has no limitations on the number of communication systems, the number of communication bands, the number of antennas, and/or the number of controllable components (e.g., tunable antenna matching components). For example, any wireless communication device using the proposed solution for intentionally degrading efficiency of at least one antenna to improve efficiency of other coexisting antenna(s) falls within the scope of the present invention.

In above embodiments shown in FIG. 1 and FIG. 7, the proposed solution is applied to multiple antennas used by respective communication systems. However, the proposed solution may also be applied to multiple antennas used by a single communication system.

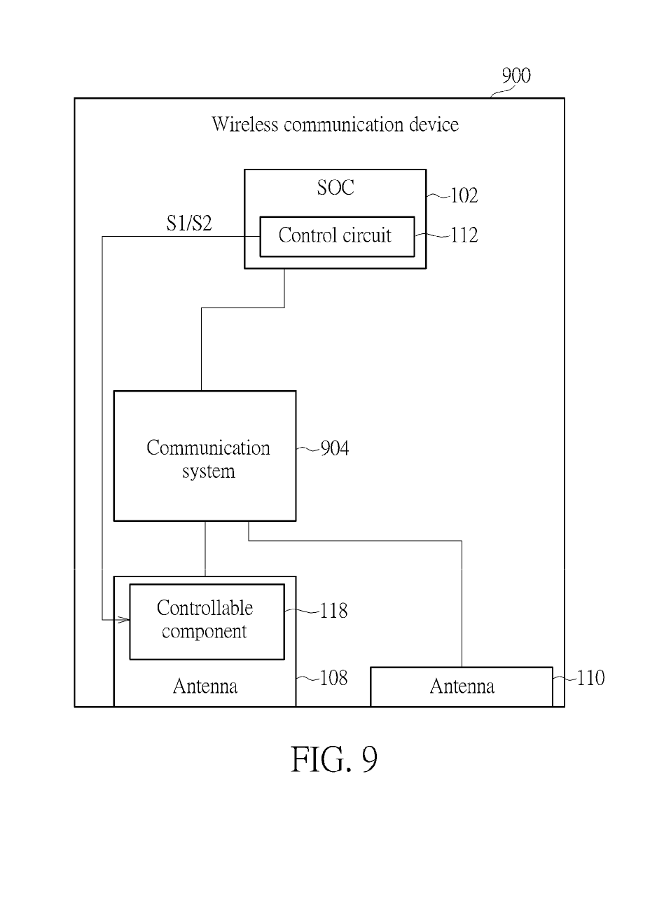

FIG. 9 is a diagram illustrating one alternative wireless communication device according to an embodiment of the present invention. The wireless communication device 900 may be obtained by applying some modifications to the wireless communication device 100 shown in FIG. 1. For example, the communication system 106 may be omitted, and the communication system 104 may be replaced by the communication system 904 that is coupled to the antennas 108 and 110. Hence, the communication system 904 may be configured to use one or both of the antennas 108 and 110 for wireless communication. When the antenna 108 is active, the control circuit 112 may set the controllable component 118 according to the first setting S1. When the antenna 108 is inactive, the control circuit 112 may set the controllable component 118 according to the second setting S2. Hence, the wireless communication method shown in FIG. 6 may also be employed by the wireless communication device 900 for antenna efficiency improvement of antennas operating under a multi-antenna coexistence environment.

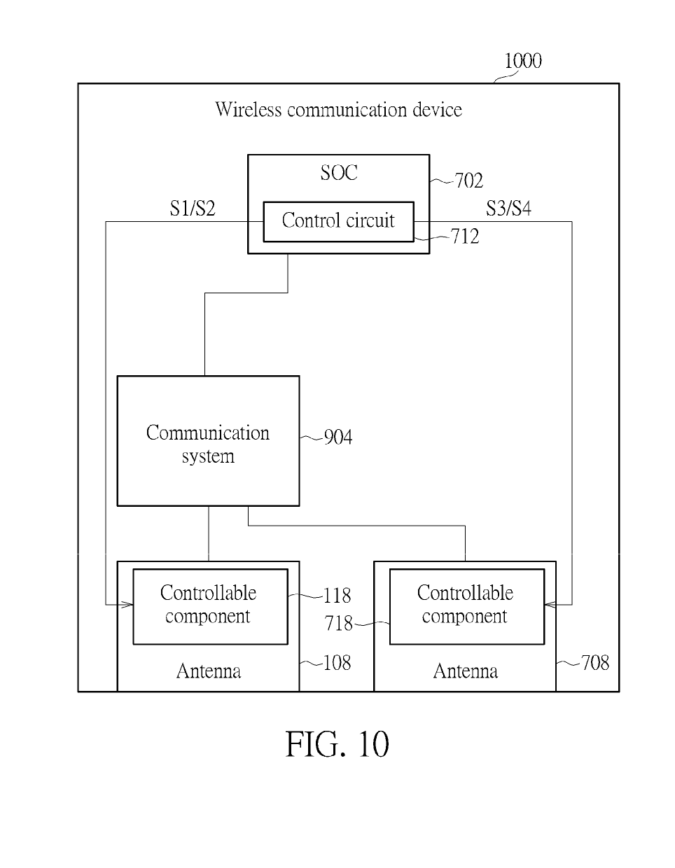

FIG. 10 is a diagram illustrating another alternative wireless communication device according to an embodiment of the present invention. The wireless communication device 1000 may be obtained by applying some modifications to the wireless communication device 700 shown in FIG. 7. For example, the communication system 106 may be omitted, and the communication system 104 may be replaced by the communication system 904 that is coupled to the antennas 108 and 708. Hence, the communication system 904 may be configured to use one or both of the antennas 108 and 708 for wireless communication. When the antenna 108 is active, the control circuit 712 may set the controllable component 118 according to the first setting S1. When the antenna 108 is inactive, the control circuit 712 may set the controllable component 118 according to the second setting S2. When the antenna 708 is active, the control circuit 712 may set the controllable component 718 according to the third setting S3. When the antenna 708 is inactive, the control circuit 712 may set the controllable component 718 according to the fourth setting S4. Hence, the wireless communication method shown in FIG. 8 may also be employed by the wireless communication device 1000 for antenna efficiency improvement of antennas operating under a multi-antenna coexistence environment.

As a person skilled in the art can readily understand details of the wireless communication devices 900 and 1000 after reading above paragraphs, further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

1. A wireless communication device for performing wireless communication via at least one of a plurality of antennas, the antennas comprising a first antenna and a second antenna, the first antenna comprising at least one first controllable component; the wireless communication device comprising:
at least one communication system, arranged to perform the wireless communication via at least one of the plurality of antennas; and
a control circuit, arranged to set the at least one first controllable component according to a first setting when the first antenna and the second antenna are active, and set the at least one first controllable component according to a second setting when the first antenna is inactive and the second antenna is active, wherein the second setting is different from the first setting.

2. The wireless communication device of claim 1, wherein at least one of the first setting and the second setting is configured for impedance matching adjustment.

3. The wireless communication device of claim 1, wherein the at least one first controllable component comprises at least one of a diode, a switch, a tunable capacitor and an impedance matching module.

4. The wireless communication device of claim 1, wherein efficiency of the first antenna with the at least one first controllable component set according to the second setting is lower than efficiency of the first antenna with the at least one first controllable component set according to the first setting.

5. The wireless communication device of claim 1, wherein efficiency of the second antenna under a condition that the at least one first controllable component is set according to the second setting is higher than efficiency of the second antenna under a condition that the at least one first controllable component is set according to the first setting.

6. The wireless communication device of claim 1, wherein isolation between the first antenna and the second antenna under a condition that the at least one first controllable component is set according to the second setting is higher than isolation between the first antenna and the second antenna under a condition that the at least one first controllable component is set according to the first setting.

7. The wireless communication device of claim 1, wherein the second antenna comprises at least one second controllable component; and the control circuit is further arranged to set the at least one second controllable component according to a third setting when the first antenna and the second antenna are active, and set the at least one second controllable component according to a fourth setting when the first antenna is active and the second antenna is inactive, where the fourth setting is different from the third setting.

8. The wireless communication device of claim 1, wherein the at least one communication system comprises:
a first communication system, arranged to perform communication in at least a first communication band via the first antenna; and
a second communication system, arranged to perform communication in at least a second communication band via the second antenna.

9. The wireless communication device of claim 8, wherein the first communication band is overlapped with the second communication band.

10. The wireless communication device of claim 8, wherein each of the first communication band and the second communication band is below 1 GHz.

11. The wireless communication device of claim 8, wherein each of the first communication band and the second communication band is above 1 GHz.

12. A wireless communication method for performing wireless communication via at least one of a plurality of antennas, the antennas comprising a first antenna and a second antenna, the first antenna comprising at least one first controllable component; the wireless communication method comprising:
configuring at least one communication system to perform the wireless communication via at least one of the plurality of antennas;
when the first antenna and the second antenna are active, setting the at least one first controllable component according to a first setting; and
when the first antenna is inactive and the second antenna is active, setting the at least one first controllable component according to a second setting different from the first setting.

13. The wireless communication method of claim 12, wherein at least one of the first setting and the second setting is configured for impedance matching adjustment.

14. The wireless communication method of claim 12, wherein the at least one first controllable component comprises at least one of a diode, a switch, a tunable capacitor and an impedance matching module.

15. The wireless communication method of claim 12, wherein efficiency of the first antenna with the at least one first controllable component set according to the second setting is lower than efficiency of the first antenna with the at least one first controllable component set according to the first setting.

16. The wireless communication method of claim 12, wherein efficiency of the second antenna under a condition that the at least one first controllable component is set according to the second setting is higher than efficiency of the second antenna under a condition that the at least one first controllable component is set according to the first setting.

17. The wireless communication method of claim 12, wherein isolation between the first antenna and the second antenna under a condition that the at least one first controllable component is set according to the second setting is higher than isolation between the first antenna and the second antenna under a condition that the at least one first controllable component is set according to the first setting.

18. The wireless communication method of claim 12, wherein the second antenna comprises at least one second controllable component; and the wireless communication method further comprises:
when the first antenna and the second antenna are active, setting the at least one second controllable component according to a third setting; and
when the first antenna is active and the second antenna is inactive, setting the at least one second controllable component according to a fourth setting different from the third setting.

19. The wireless communication method of claim 12, wherein configuring the at least one communication system comprises:
configuring a first communication system to perform communication in at least a first communication band via the first antenna; and
configuring a second communication system to perform communication in at least a second communication band via the second antenna.

20. The wireless communication method of claim 19, wherein the first communication band is overlapped with the second communication band.

21. The wireless communication method of claim 19, wherein each of the first communication band and the second communication band is below 1 GHz.

22. The wireless communication method of claim 19, wherein each of the first communication band and the second communication band is above 1 GHz.
